(19) United States
(12) Patent Application Publication
(10) Pub. No.: US 2010/0245824 A1
(43) Pub. Date: Sep. 30, 2010

(54) METHOD FOR ORIENTING A PARALLAX BARRIER SCREEN ON A DISPLAY SCREEN

(76) Inventors: Juergen SCHWARZ, Apolda (DE); Lars Bergmann, Weimar (DE); Stephan Otte, Jena (DE); Ferenc Torma, Jena (DE)

Correspondence Address: Muncy, Geissler, Olds & Lowe, PLLC, 4000 Legato Road, Suite 310, FAIRFAX, VA, 22033, US

(21) Appl. No.: 12/748,917

(22) Filed: Mar. 29, 2010

Related U.S. Application Data
(63) Continuation of application No. PCT/DE2007/002134, filed on Nov. 26, 2007.

(30) Foreign Application Priority Data
Sep. 28, 2007 (DE) DE102007047470.0

(51) Int. Cl. G01B 11/27

(52) U.S. Cl. 356/400

(57) ABSTRACT

A method for orienting a parallax barrier screen on a display screen with picture elements x(i,j) in a grid comprising rows i and columns j for the purpose of producing a display screen for three-dimensional representation. This method includes the steps of: temporary application of a positioning marker, observation of the positioning marker by means of a camera, relative orientation of the display screen, removal of the positioning marker, positioning of the parallax barrier screen in front of the picture area of the display screen display of a test picture, which comprises various views, where k=1, . . . , n and n=6 or n=7, on the picture elements x(i,j) with rows i and columns j, observation of the displayed test picture through the parallax barrier screen by the camera, orientation of the parallax barrier screen in front of the display screen. The method according to the invention can be carried out quickly and is therefore suitable for industrial use for the manufacture of display screens for three-dimensional representation.

This nonprovisional application is a continuation of International Application No. PCT/DE2007/002134, which was filed on Nov. 26, 2007, and which claims priority to German Patent Application No. 10 2007 047 470.0, which was filed in Germany on Sep. 28, 2007, and which are both herein incorporated by reference.

### BACKGROUND OF THE INVENTION

1. Field of the Invention

The invention relates to a method for orienting a parallax barrier screen on a display screen.

2. Description of the Background Art

Approaches to the field of parallax barriers have existed for some time. A pioneer in this field was Frederic Ives, who in the patent publication GB190418672 A proposed a system with a “line screen” for 3-D imaging. Further, fundamental findings on the use of barrier screens for 3-D imaging are described in the publication by Sam H. Kaplan “Theory of parallax barriers,” Journal of SMPTE, Vol. 59, No. 7, pp. 11-21, July 1952.

A widespread dissemination of autostereoscopic systems did not succeed for a long time, however. An actual renaissance of 3-D systems did not occur until the eighties of the 20th century, because of the now available computing power and novel display technologies. In the 1990s the number of patent applications and publications for glasses-free 3-D visualizations substantially increased.

In Japanese patent publication JP 08331605 AA, Masutani Takeshi et al. (Sanyo) describe a step barrier in which a transparent barrier element has approximately the dimensions of a color subpixel (R, G, or B). With this technology, it was possible for to transfer the resolution loss occurring in most autostereoscopic systems in a horizontal direction, due to the representation of simultaneous multiple views (at least two, preferably more than two views), in part also to the vertical direction. A disadvantage here, as in all barrier methods, is the high light loss. In addition, the stereo contrast with sideways movement of the viewer changes from almost 100% to about 50% and then increases again to 100%, which has the result of a fluctuating 3-D image quality within the viewing space.

In German Pat. Appl. DE 100 03 326 C2, Armin Grasnick et al. achieved a refinement of the barrier technology in regard to two-dimensional structured wavelength-selective filter arrays to produce a 3-D impression. A disadvantage here as well, however, is the greatly reduced brightness of this type of 3-D systems in comparison with a 2-D display.

Finally, Wolfgang Tzschoppe et al. filed the International Pat. Appl. WO 2004/077839 A1, which relates to a barrier technology improved in regard to brightness. Based on the approach of a step barrier disclosed in JP 08331605 AA and DE 100 03 326 C2, a special line-to-space ratio of the transparent to the opaque barrier filter elements is presented here, which is greater than 1/n with n being the number of the displayed viewpoints. The embodiments and teaching disclosed in this publication, however, usually produce unpleasant moiré effects and/or a greatly limited depth perception, because the stereo contrast is greatly reduced, compared with, for instance, the teaching of JP 08-331605 AA.

In U.S. Pat. Appl. 2006/0051109 A1 (Lim et al.), the manufacturing of a 3-D screen is described, in which a 3-D imaging device (e.g., a lens or a barrier screen) is aligned. before a display screen and then with the correct alignment an adhesive bond is hardened. In this regard, a black stripe is characteristically produced, which is observed by an operator or camera. A particular disadvantage here is that the required correctness is not necessarily achieved during aligning with use of a black stripe or a black area alone. The additionally proposed methods of using at least one left and one right image with different image contents in each case of a completely white and a completely black area as an alignment test pattern, on the contrary, require the evaluation of two disjunctive partial images, namely, the left and the right.

German Pat. DE 102 52 830 B3 (Maly-Motta) describes an autostereoscopic adapter for a flat panel display, which undergoes automatic calibration via an electro-optic sensor. No statements are made about the test patterns employed in this regard, however, so that no conclusions can be drawn on the quality of the final calibration.

### SUMMARY OF THE INVENTION

It is therefore an object of the invention to provide a way for orienting a parallax barrier screen on a display screen to generate a display screen for three-dimensional representation with the simplest means possible, so that a sufficiently precise orientation is realized within a short time. It is also to be possible in this regard, even in spaces with a small or too high room height, to produce display screens for three-dimensional representation that have a large viewing distance (of a few meters).

This object is achieved according to an embodiment the invention by a method for orienting a parallax barrier screen on a display screen with pixels x(i,j) in a grid of rows i and columns j to produce a display screen for three-dimensional representation. Temporary application of a positioning marker, preferably approximately in the middle of the image area of the display screen. Then, the positioning marker is observed by means of a camera, whereby the positioning marker is imaged via at least one deflection mirror and whereby the image taken by the camera is displayed on a monitor, which also contains a positioning marker approximately in the middle of its image area. The display screen is then relatively orientated, so that both positioning markers are aligned in the image on the monitor, and so that the left, right, top, or bottom image edge of the image area of the display screen in the image on the monitor is arranged parallel to the left, right, top, or bottom image edge of the image area of the monitor. The positioning marker is removed from the image area of the display screen. The parallax barrier screen is positioned in front of the image area of the display screen. A test image is displayed which is generated by the pixels x(i,j) with rows i and columns j and has different views A(k) with k=1, n and n=6 or n=7. The displayed test image is observed through the parallax barrier screen from a defined distance by means of the camera, whereby the image taken by the camera is shown in turn on the monitor. Then the parallax barrier screen is orientated in front of the display screen with use of the image displayed on the monitor.

A requirement can be the pixel-precise display of the camera image on the monitor. Preferably, the camera and monitor have an identical resolution and the camera image is shown in the full screen mode on the monitor.

Because assembly shops usually do not have the necessary height to position the camera in front of the lying display screen, a deflection mirror can be arranged preferably on the ceiling, so that the light beam is folded, so that also in the case of rather small room heights greater distances (of several meters) of the camera to the display screen are made possible.

The orientation step can be carried out in principle manually by an operator or automatically by a robot or optionally even by a combination of an operator and a robot.

The index i addresses the rows and the index j the columns on the grid of pixels x(i,j).

The number of six or seven views in the test image, on the one hand, permits an efficient test image creation and, on the other, produces a sufficiently good test effect to achieve the correct orientation.

The parameters for the parallax barrier screen can be calculated, for example, simply with the help of the two equations (1) and (2) known from the aforementioned Kaplan article. This provides all necessary relations between the distance s, between the grid of pixels x(i,j) and the parallax barrier screen, the, for example, average eye distance in humans set to 65 mm, the viewing distance, the (horizontal) period length of the transparent sections of the barrier, and the stripe width of the transparent sections. Some of the aforementioned publications also provide further design information for parallax barrier screens, which are sufficiently known to the person skilled in the art.

In most cases, but not always, the image of the shown test image, taken by the camera after the orientation, comprises at least 40% of the pixels of precisely one of the n=6 or n=7 views A(k).

To make the method of the invention even more advantageous for industrial use, at least one, preferably all, of the n=6 or n=7 views A(k) contain alphanumeric characters, preferably model or serial numbers and/or identification marks/objects. This makes sure that the right test image is also used for a specific display screen model, for example, when the model number is seen in the image and the operator or robot always compares this model number with that of the current display screen being worked on.

After the orientation of the parallax barrier screen, in addition, another step of storing the image, taken by the camera, of the presented test image is performed, whereby preferably a clear assignment to the physical display screen and/or the parallax barrier screen oriented thereon is made, for example, by naming of the image file, to be stored, for the image in the form of a serial number of the display screen. In this way, it can be unequivocally demonstrated later that a specific display screen was properly converted to the 3-D state by the attachment and/or orientation of the parallax barrier screen.

Furthermore, the pixels x(i,j) in each case correspond to individual color subpixels (R, G, or B) or clusters of color subpixels (e.g., RG, GB, or RGBR or others) or full-color pixels, whereby full-color pixels are taken to mean both white-blending structures of RGB color subpixels, therefore RGB triplets, and actual full color pixels depending on the imaging technology, as is often common, for instance, in projection screens.

The parallax barrier screen can be permanently applied to the display screen at a defined distance s in front of the display screen after the orientation. This would then be a permanent modification.

In contrast, it is also possible in another embodiment, that after the orientation step the parallax barrier screen is not applied to the display screen, but that in another step applied to the parallax barrier screen and/or to the display screen are markers that allow a later oriented application of the parallax barrier screen to the display screen, without having to repeat the entire method of the invention at this later point in time.

The display screen can be a color LCD screen, a plasma display, a projection screen, an LED-based display, an OLED-based display, an SED display, or a VFD display.

The parallax barrier screen can comprise transparent and opaque sections inclined at an angle a relative to the vertical. It includes a glass substrate, to the back of which the barrier structure is applied.

The barrier structure, on the one hand, can be an exposed and developed photographic film, which is laminated to the back of the glass substrate, whereby preferably the emulsion layer of the photographic film faces the glass substrate.

Alternatively, the opaque areas of the barrier structure can be formed by color printed on the glass substrate. The transparent areas in this case arise simply by the omission of the color on the corresponding areas.

Additional manufacturing methods are known from the state of the art and require no further explanation here.

In the method of the invention, the arrangement of the image section data of the different views A(k) in the presented test image on the grid of pixels x(i,j) occurs advantageously in a two-dimensional periodic pattern, whereby the period length in the horizontal and vertical direction preferably does not comprise more than 32 pixels x(i,j) in each case. Exceptions to this upper limit of 32 pixels x(i,j) in each case are allowable.

The angle, which spans the horizontal and vertical period length of the two-dimensional periodic pattern as opposite and adjacent sides, should normally correspond substantially to the inclination angle a of the transparent sections on the parallax barrier screen with respect to the vertical.

The parallax barrier screen can have a component for reducing spurious light reflections, such as at least one interference optical antireflection coating.

During the later 3-D representation on the display screen with the oriented parallax barrier screen, the views A(k) can each correspond to different perspectives of a scene or an object, as in various other 3-D reproduction methods.

The deflection mirror can be arranged at an angle of 45 degrees in each case both to the perpendicular bisector of the image area of the display screen and to the optical axis of the camera. In keeping with the spatial conditions, the camera and deflection mirror, however, can also assume a positioning to one another different from the preferred positioning.

Further, the positioning markers can be crosses, which are predefined, for example, by the diagonals of the display screen and/or of the monitor. For the temporary application of the positioning marker, preferably approximately in the middle of the image area of the display screen, a precisely fitting template is used preferably, the outer dimensions of which correspond approximately to those of the image area of the display screen, whereby the form of the positioning marker is omitted from the template.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows the schematic structure for realizing the method of the invention;

FIG. 2 shows an exemplary barrier structure of a parallax barrier screen for use in the method of the invention,

FIG. 3 shows an exemplary image combination of the image section data of different views in the test image; and

FIG. 4 shows an exemplary structure of a template for a positioning marker for use in the method of the invention.

### DETAILED DESCRIPTION

It is noted that the drawings are not to scale. This refers in particular also to the angular dimensions.

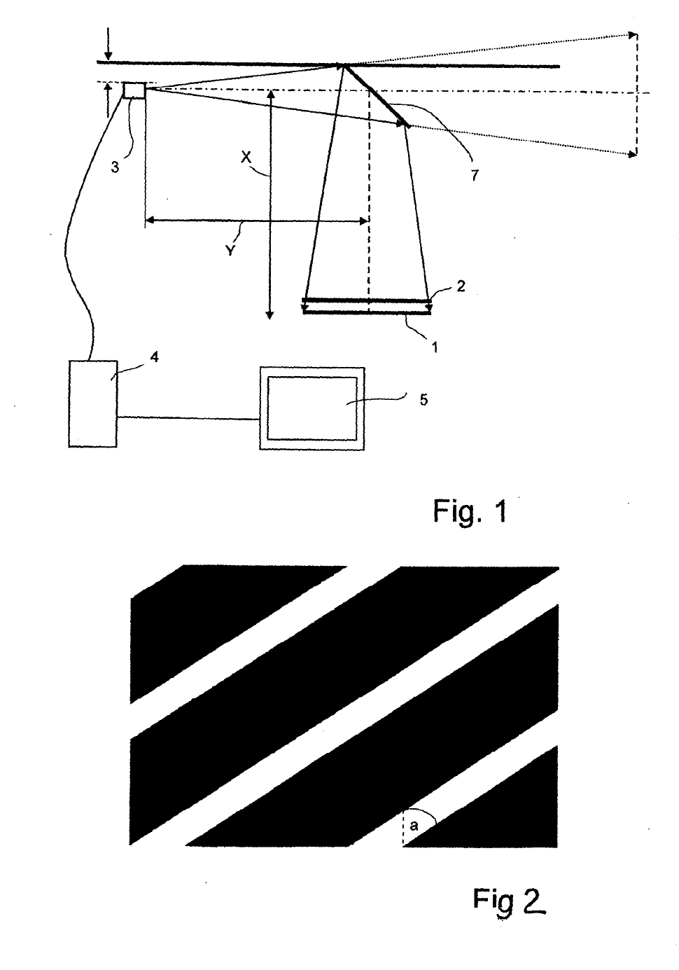

FIG. 1 shows the schematic structure for realizing the method of the invention. In this case, parallax barrier screen 2 is oriented at the distance s on a display screen 1 with pixels x(i,j) in a grid having rows i and columns j, as a result of which a display screen for three-dimensional representation arises. Furthermore, a camera 3 can be seen, which is suitable in general for taking two-dimensional pictures and whose output signal is supplied here, by way of example, by means of a frame grabber card to a computer 4. Computer 4 converts this signal accordingly and enables the display on a monitor 5.

The method of the invention is carried out in the following steps: First, a positioning marker 6a is applied temporarily approximately in the middle or the edges of the image area of display screen 1. Display screen 1 with positioning marker 6a is now recorded with camera 3, whereby imaging takes place at positioning marker 6a via at least one deflection mirror 7, according to FIG. 1, and whereby the image taken by camera 3 is shown via computer 4 on monitor 5. A positioning marker 6b with the same shape is also preferably applied in the middle of the image area of monitor 5. Positioning marker 6b in this regard can be generated simply by computer 4 and in addition shown with the image of display screen 1 on monitor 5. Display screen 1 is now oriented until both positioning markers 6a and 6b are aligned on monitor 5, so that the left, right, top, or bottom image edge of the image area of display screen 1 in the image on monitor 5 appears parallel to the left, right, top, or bottom image edge of the image area of monitor 5. The positioning marker 6a is now again removed from the image area of display screen 1 and parallax barrier screen 2 is positioned in front of the image area of display screen 1. Subsequently, a test image is generated by the pixels x(i,j) with rows i and columns j, which has different views A(k) with k=1, n and n=6 or n=7. The test image generated in this way is taken through parallax barrier screen 2 from a defined distance by means of camera 3 and displayed on monitor 5. The orientation of parallax barrier screen 2 in front of display screen 1 occurs with use of the image shown on monitor 5.

The orientation step is carried out, for example, manually by an operator.

Camera 3 can be arranged at a distance in front of parallax barrier screen 2, which corresponds to a selected 3-D viewing distance in front of display screen 1. The distance is usually determined, as is known to the person skilled in the art, by the distance s between display screen 1 and parallax barrier screen 2 in conjunction with other parameters, which are listed, for example, in the aforementioned publication by Kaplan.

The light beam is folded by deflection mirror 7, according to FIG. 1, so that also in the case of a small room height, larger distances (of a few meters) of camera 3 to display screen 1 are made possible. Preferably, in this case, camera 3 is positioned via deflection mirror 7 optically perpendicular before the center of display screen 1. According to FIG. 1, in this regard, the necessary optical distance of camera 3 to display screen 1 is the sum of the distances X and Y.

It is favorable in addition if deflection mirror 7 is arranged at an angle of 45 degrees in each case both to the perpendicular bisector of the image area of display screen 1 and to the optical axis of camera 3, as can also be derived from FIG. 1.

FIG. 2 shows an exemplary barrier structure of a parallax barrier screen 2 for use in the method of the invention. Parallax barrier screen 2 comprises transparent and opaque sections inclined at an angle a relative to the vertical. It includes a glass substrate, to the back of which the barrier structure is applied. Other embodiments are possible, such as, for instance, substrates that do not have glass (e.g., are made of plastic).

The barrier structure here, for example, is an exposed and developed photographic film, which is laminated to the back of the glass substrate, whereby preferably the emulsion layer of the photographic film faces the glass substrate. Advantageously, parallax barrier screen 2 has a component for reducing spurious light reflections, preferably at least one interference optical antireflection coating.

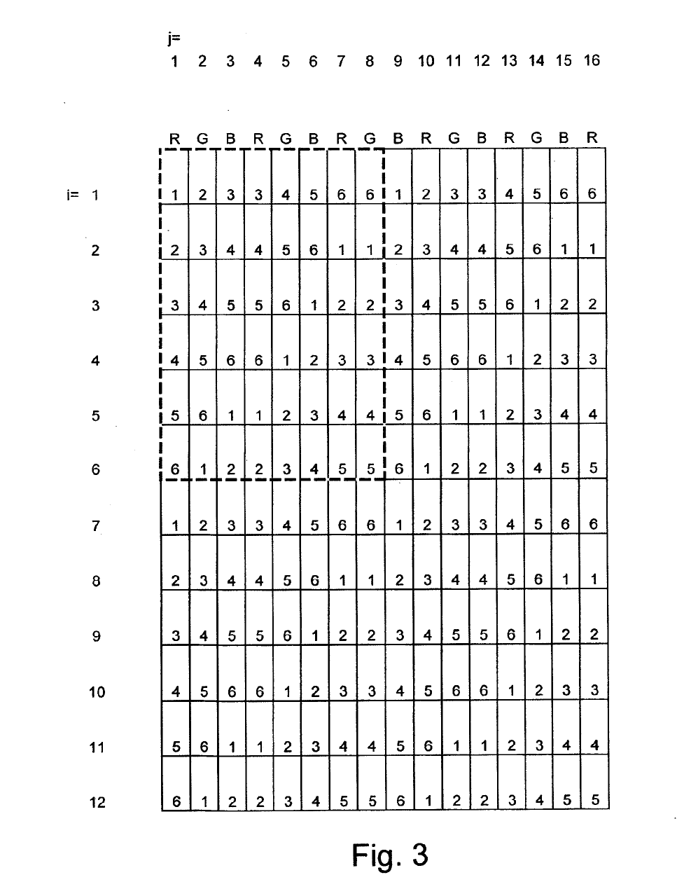

Further, FIG. 3 shows an exemplary image combination of the image section data of different views in the test image, which is represented on the pixels x(i,j). In the method of the invention, the arrangement of the image section data of different views A(k) in the presented test image on the grid of pixels x(i,j) occurs advantageously in a two-dimensional periodic pattern.

The angle that spans the horizontal and vertical period length of the two-dimensional periodic pattern as opposite and adjacent sides should normally correspond substantially to the inclination angle a of the transparent sections on parallax barrier screen 2 with respect to the vertical.

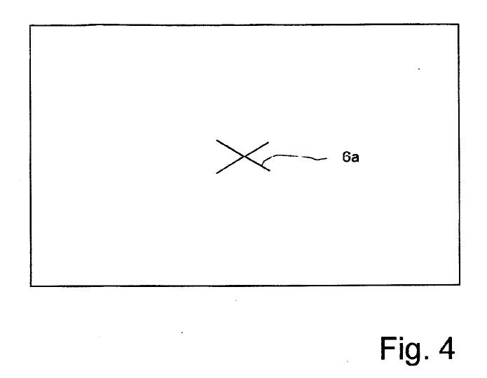

Advantageously, positioning markers 6a and 6b can be two bars intersecting at right angles or obliquely, whereby preferably at least one bar runs along a diagonal of display screen 1 and the intersection is arranged in the middle of the display screen, as indicated in FIG. 4. For the temporary application of positioning marker 6a, approximately in the middle of the image area of display screen 1, preferably a precisely fitting template is used, the outer dimensions of which correspond approximately to those of the image area of display screen 1, whereby the form of the positioning marker is omitted from the template. Positioning marker 6b will usually have the same form, but this is not absolutely necessary.

To make the method of the invention even more advantageous for industrial use, at least one, preferably all, of the n=6 views A(k) contain alphanumeric characters, preferably model or serial numbers and/or identification marks/objects. This makes sure that the correct test image is used for a specific display screen model.

After the orientation of parallax barrier screen 2, in addition, another step of storing the image, taken by camera 3, of the displayed test image can be performed, whereby preferably a clear assignment to the physical display screen 1 and/or parallax barrier screen 2 oriented thereon is made, for example, by naming of the image file, to be stored, for the image in the form of a serial number of display screen 1.

In the exemplary embodiment, parallax barrier screen 2 is applied permanently to display screen 1 by means of a spacer element to preserve the distance s defined further above, for example, glued or screwed on.

Display screen 1 preferably may be a color LCD screen.

During the later 3-D representation on display screen 1 with oriented parallax barrier screen 2, the views A(k) each correspond to different perspectives of a scene or an object, as in various other 3-D reproduction methods.

For further illustration of possible implementations of the method of the invention, additional exemplary details and parameters are given hereinafter.

The advantages of the invention are multifaceted. In particular, the method of the invention permits the orientation of a parallax barrier screen 2 on a display screen 1 to produce a display screen for three-dimensional representation within a relatively short time. It can be used further for display screens of various sizes, in this respect therefore very flexibly. Moreover, the orientation can be implemented manually, automatically, or semiautomatically.

It is also possible as required, even in spaces with a small room height to produce display screens for three-dimensional representation, which have a large viewing distance (of several meters).

The invention can be realized with simple and customary means.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for orientating a parallax barrier screen on a display screen with pixels in a grid of rows i and columns j to produce a display screen for three-dimensional representation, the method comprising:
temporarily applying a positioning marker approximately on an image area of the display screen;
observing the positioning marker via a camera, the positioning marker being imaged via at least one deflection mirror, the image taken by the camera being shown on a monitor that also contains a positioning marker approximately in a middle of an image area of the monitor;
relatively orientating the display screen such that in the image on the monitor both positioning markers are aligned and also limiting edges of the image area of the display screen in the image on the monitor appear parallel to the limiting edges of the image area of the monitor;
removing the positioning marker from the image area of the display screen;
positioning the parallax barrier screen in front of the image area of the display screen;
displaying a test image via the pixels with rows i and columns j, which have different views A(k) with k=1, n and n=6 or n=7;
observing the displayed test image through the parallax barrier screen from a defined distance by the camera, the image taken by the camera being shown on the monitor; and
orientating the parallax barrier screen in front of the display screen via the image displayed on the monitor.

2. The method according to claim 1, wherein the image taken by the camera after the orientation of the presented test image comprises at least 40% of the pixels of precisely one of the n=6 or n=7 views A(k).

3. The method according to claim 1, wherein alphanumeric characters, including model or serial numbers and/or identification marks/objects, are incorporated into at least one or all of the n=6 or n=7 views A(k).

4. The method according to claim 1, wherein after the orientation of the parallax barrier screen, another step of storing the image taken by the camera of the presented test image is performed, wherein a clear assignment to the physical display screen and/or the parallax barrier screen oriented thereon is made by naming the image file to be stored for the image in a form of a serial number of the display screen.

5. The method according to claim 1, wherein the pixels correspond to color subpixels or clusters of color subpixels or full-color pixels.

6. The method according to claim 1, wherein the parallax barrier screen is applied permanently to the display screen at a defined distance in front of the display screen after the orientation.

7. The method according to claim 1, wherein after the orientation step, the parallax barrier screen is not applied to the display screen, wherein in another step markers are applied to the parallax barrier screen and/or to the display screen so that a later oriented application of the parallax barrier screen to the display screen is made possible.

8. The method according to claim 1, wherein the display screen is a color LCD screen, a plasma display, a projection screen, an LED-based display, an OLED-based display, an SED display, or a VFD display.

9. The method according to claim 1, wherein the parallax barrier screen comprises transparent and opaque sections inclined at an angle relative to a vertical.

10. The method according to claim 1, wherein the parallax barrier screen has a glass substrate, to a back of which the barrier structure is applied.

11. The method according to claim 10, wherein the barrier structure is an exposed and developed photographic film that is laminated to the back of the glass substrate, and wherein an emulsion layer of the photographic film faces the glass substrate.

12. The method according to claim 10, wherein opaque areas of the barrier structure are formed by color printed on the glass substrate.

13. The method according to claim 1, wherein the parallax barrier screen has a component for reducing spurious light reflections.

14. The method according to claim 1, wherein the positioning markers are formed by two bars intersecting at right angles or obliquely, wherein at least one bar runs along a diagonal of the display screen and an intersection is arranged in each case in a middle of the display screen or the monitor.

15. The method according to claim 1, wherein the deflection mirror is arranged at an angle of 45 degrees in each case both to a perpendicular bisector of the image area of the display screen and to an optical axis of the camera.

16. The method according to claim 1, wherein for the temporary application of the positioning marker, approximately in the middle of the display screen, a precisely fitting template is used, the outer dimensions of the template corresponding approximately to those of the image area of the display screen, and wherein a form of the positioning marker is omitted from the template.

17. The method according to claim 13, wherein the component includes at least one interference optical antireflection coating.
